(19) United States
(12) Patent Application Publication
(10) Pub. No.: US 2026/0274641 A1
(43) Pub. Date: Sep. 17, 2026

(54) DEVICES, SYSTEMS, AND METHODS FOR GENERATING CUSTOMIZED BEVERAGES

(71) Applicant: RBAR, LLC, Nasville, TN (US)

(72) Inventor: Andrew Lee, Nashville, TN (US)

(73) Assignee: RBAR, LLC, Nasville, TN (US)

(21) Appl. No.: 19/168,196

(22) PCT Filed: May 24, 2023
(86) PCT No.: PCT/US2023/023316

§ 371 Date: Sep. 23, 2025

Related U.S. Application Data
(60) Provisional application No. 63/454,363, filed on Mar. 24, 2023.

(51) Int. Cl. B67D 1/00; B67D 1/08

(52) U.S. Cl. CPC B67D 1/0041; B67D 1/0021; B67D 1/0857; B67D 1/0888; B67D 2210/00076; B67D 2210/00086; B67D 2210/00104; B67D 2210/00125

(57) ABSTRACT

Devices, systems, and methods for generating customized beverages. In a method of creating a prepared beverage, the method comprises the steps of receiving a beverage order from an individual via software instruction, instructing the creation of a prepared beverage using a drink creation system based upon the beverage order, the drink creation system comprising a first cart having a plurality of beverage receptacles therein, a beverage dispenser coupled to the plurality of beverage receptacles, and a dispenser controller in communication with the beverage dispenser, selecting a beverage cup based upon the software instruction, dispensing the prepared beverage using the beverage dispenser, and delivering the prepared beverage to a location based upon the software instruction.

### PRIORITY

The present application is related to, and claims the priority benefit of, U.S. Provisional Patent Application Ser. No. 63/454,363, filed Mar. 24, 2023, the contents of which are incorporated herein directly and by reference in their entirety.

### BRIEF SUMMARY

The present disclosure includes disclosure of a method of creating a prepared beverage, comprising the steps of receiving a beverage order from an individual via software instruction, instructing the creation of a prepared beverage using a drink creation system based upon the beverage order, the drink creation system comprising a first cart having a plurality of beverage receptacles therein, a beverage dispenser coupled to the plurality of beverage receptacles, and a dispenser controller in communication with the beverage dispenser, selecting a beverage cup based upon the software instruction, dispensing the prepared beverage using the beverage dispenser, and delivering the prepared beverage to a location based upon the software instruction.

The present disclosure includes disclosure of a method of creating a prepared beverage, wherein the step of selecting the beverage cup is performed after instructions appearing on a screen of the dispenser controller indicates which type of cup to use.

The present disclosure includes disclosure of a method of creating a prepared beverage, further comprising the step of adding shaved ice to the beverage cup prior to the step of dispensing the prepared beverage.

The present disclosure includes disclosure of a method of creating a prepared beverage, wherein the step of adding shaved ice is performed after the shaved ice is prepared by shaving cubed ice using an ice shaver.

The present disclosure includes disclosure of a method of creating a prepared beverage, wherein the step of adding shaved ice is performed after instructions appearing on a screen of the dispenser controller indicates the use of shaved ice.

The present disclosure includes disclosure of a method of creating a prepared beverage, further comprising the step of adding cubed ice to the beverage cup after to the step of dispensing the prepared beverage.

The present disclosure includes disclosure of a method of creating a prepared beverage, wherein the step of adding cubed ice is performed after instructions appearing on a screen of the dispenser controller indicates the use of cubed ice.

The present disclosure includes disclosure of a method of creating a prepared beverage, further comprising the step of operating an immersion device at a first speed to whip the prepared beverage prior to the step of delivering the prepared beverage.

The present disclosure includes disclosure of a method of creating a prepared beverage, wherein the step of operating an immersion device is performed after instructions appearing on a screen of the dispenser controller indicates the use of the immersion device to whip the prepared beverage.

The present disclosure includes disclosure of a method of creating a prepared beverage, further comprising the step of operating an immersion device at a second speed to blend the prepared beverage prior to the step of delivering the prepared beverage.

The present disclosure includes disclosure of a method of creating a prepared beverage, wherein the step of operating an immersion device is performed after instructions appearing on a screen of the dispenser controller indicates the use of the immersion device to blend the prepared beverage.

The present disclosure includes disclosure of a method of creating a prepared beverage, wherein the first cart is configured to move in a lateral direction using a plurality of wheels or castors, and wherein the method further comprises the step of moving the first cart from a first location to a second location.

The present disclosure includes disclosure of a method of creating a prepared beverage, wherein the step of dispensing the prepared beverage is performed by dispensing one or more liquid beverages present within one or more beverage receptacles of the plurality of beverage receptacles.

The present disclosure includes disclosure of a method of creating a prepared beverage, wherein the step of dispensing the prepared beverage is performed after instructions appearing on a screen of the dispenser controller indicates the use of the one or more liquid beverages to prepare the prepared beverage.

The present disclosure includes disclosure of a method of creating a prepared beverage, wherein the step of instructing is performed based upon the beverage order received by the dispenser controller.

The present disclosure includes disclosure of a method of creating a prepared beverage, wherein the dispenser controller is configured to display information regarding the beverage order on a screen coupled to or formed as part of the dispenser controller.

The present disclosure includes disclosure of a method of creating a prepared beverage, wherein the first cart is refrigerated and can be set to a first desired refrigerated temperature.

The present disclosure includes disclosure of a method of creating a prepared beverage, wherein the drink creation system further comprises an ice source positioned upon or within the first cart, the ice source configured to provide a quantity of ice.

The present disclosure includes disclosure of a method of creating a prepared beverage, wherein the drink creation system further comprises a liquid waste receptacle within the first cart, the liquid waste receptacle configured to receive and retain liquid waste.

The present disclosure includes disclosure of a method of creating a prepared beverage, wherein the drink creation system further comprises a carbon dioxide source positioned upon or within the first cart.

The present disclosure includes disclosure of a method of creating a prepared beverage, wherein the drink creation system further comprises a printer configured to print a beverage label containing information pertaining to the beverage order, and wherein the method further comprises the step of placing the beverage label on the beverage cup prior to the step of delivering the prepared beverage.

The present disclosure includes disclosure of a method of creating a prepared beverage, wherein the drink creation system further comprises a second cart configured to move in a lateral direction using a plurality of second cart wheels or castors, the second cart operably coupled to the first cart, wherein the second cart has a second plurality of beverage receptacles therein, and wherein the second cart is refrigerated and can be set to a second desired refrigerated temperature.

The present disclosure includes disclosure of a method of creating a prepared beverage, wherein the step of dispensing the prepared beverage is performed by dispensing one or more liquid beverages present within one or more beverage receptacles of the second plurality of beverage receptacles.

The present disclosure includes disclosure of a method of creating a prepared beverage, wherein the step of dispensing the prepared beverage is performed by dispensing one or more liquid beverages present within one or more beverage receptacles of the plurality of beverage receptacles and by dispensing one or more liquid beverages present within one or more beverage receptacles of the second plurality of beverage receptacles.

The present disclosure includes disclosure of a method of creating a prepared beverage, wherein the step of receiving the beverage order from the individual via software instruction is performed after the individual selects a desired beverage from a list of potential beverages present within software used to generate the software instruction.

The present disclosure includes disclosure of a method of creating a prepared beverage, wherein the individual can use the software to customize the beverage order using at least one customization prior to placing the beverage order.

The present disclosure includes disclosure of a method of creating a prepared beverage, wherein the step of delivering the prepared beverage to a location based upon the software instruction comprises delivering the prepared beverage to the individual based upon GPS information from the beverage order.

The present disclosure includes disclosure of a method of creating a prepared beverage, wherein the step of delivering the prepared beverage to a location based upon the software instruction comprises delivering the prepared beverage to a designated pick-up location based upon information from the beverage order.

The present disclosure includes disclosure of a method of creating a prepared beverage, comprising the steps of receiving a beverage order from an individual via software instruction, instructing the creation of a prepared beverage using a drink creation system based upon the beverage order, selecting a beverage cup based upon the software instruction, optionally adding shaved ice to the beverage cup, dispensing the prepared beverage using the beverage dispenser, optionally adding cubed ice to the beverage cup, optionally using an immersion device to whip or blend the prepared beverage, and delivering the prepared beverage to a location based upon the software instruction.

The present disclosure includes disclosure of a method of creating a prepared beverage, wherein the step of selecting the beverage cup is performed after instructions appearing on a screen of the dispenser controller indicates which type of cup to use.

The present disclosure includes disclosure of a method of creating a prepared beverage, wherein the step of optionally adding shaved ice to the beverage cup is performed to add shaved ice to the beverage cup.

The present disclosure includes disclosure of a method of creating a prepared beverage, wherein the step of adding shaved ice is performed after instructions appearing on a screen of the dispenser controller indicates the use of shaved ice.

The present disclosure includes disclosure of a method of creating a prepared beverage, wherein the step of optionally adding cubed ice to the beverage cup is performed to add cubed ice to the beverage cup.

The present disclosure includes disclosure of a method of creating a prepared beverage, wherein the step of adding cubed ice is performed after instructions appearing on a screen of the dispenser controller indicates the use of cubed ice.

The present disclosure includes disclosure of a method of creating a prepared beverage, wherein the step of optionally using an immersion device to whip or blend the prepared beverage is performed to use the immersion device to whip or blend the prepared beverage.

The present disclosure includes disclosure of a method of creating a prepared beverage, wherein the step of operating an immersion device is performed after instructions appearing on a screen of the dispenser controller indicates the use of the immersion device to whip or blend the prepared beverage.

The present disclosure includes disclosure of a method of creating a prepared beverage, wherein the step of instructing is performed using the drink creation system comprising a first cart having a plurality of beverage receptacles therein, a beverage dispenser coupled to the plurality of beverage receptacles, and a dispenser controller in communication with the beverage dispenser.

The present disclosure includes disclosure of a method of creating a prepared beverage, wherein the step of dispensing the prepared beverage is performed after instructions appearing on a screen of the dispenser controller indicates the use of the one or more liquid beverages to prepare the prepared beverage.

The present disclosure includes disclosure of a drink creation system, comprising a first cart configured to move in a lateral direction using a plurality of wheels or castors, a first cart drawer configured to receive a plurality of beverage receptacles having liquid beverages therein, a beverage dispenser configured to dispense a prepared beverage, the prepared beverage comprising one or more liquid beverages, and a dispenser controller configured to receive beverage orders and to instruct the beverage dispenser to dispense the prepared beverages consistent with the beverage orders, wherein the first cart is refrigerated and can be set to a first desired refrigerated temperature.

The present disclosure includes disclosure of a drink creation system, further comprising the plurality of beverage receptacles having the liquid beverages therein.

The present disclosure includes disclosure of a drink creation system, further comprising a plurality of tubes, each tube of the plurality of tubes connected to a beverage receptacle of the plurality of beverage receptacles at a first end and to the beverage dispenser at a second end.

The present disclosure includes disclosure of a drink creation system, further comprising an ice source positioned upon or within the first cart, the ice source configured to provide a quantity of ice.

The present disclosure includes disclosure of a drink creation system, wherein the ice source is operably connected to a fresh water source positioned upon or within the first cart.

The present disclosure includes disclosure of a drink creation system, further comprising a liquid waste receptacle within the first cart, the liquid waste receptacle configured to receive and retain liquid waste.

The present disclosure includes disclosure of a drink creation system, further comprising a carbon dioxide source positioned upon or within the first cart.

The present disclosure includes disclosure of a drink creation system, wherein the carbon dioxide source is operably coupled to the beverage dispenser.

The present disclosure includes disclosure of a drink creation system, further comprising a plurality of beverage cups positioned upon the first cart.

The present disclosure includes disclosure of a drink creation system, further comprising the plurality of beverage receptacles having the liquid beverages therein, and an ice source positioned upon or within the first cart, the ice source configured to provide a quantity of ice.

The present disclosure includes disclosure of a drink creation system, wherein when a beverage order is placed using a software application, said beverage order is received by the dispenser controller, which operates to cause the beverage dispenser to dispense a prepared beverage into a beverage cup positioned relative to the beverage dispenser.

The present disclosure includes disclosure of a drink creation system, further comprising a printer configured to print a beverage label containing information pertaining to a particular beverage order.

The present disclosure includes disclosure of a drink creation system, wherein when the beverage order requires ice, ice from the ice source can be positioned within the beverage cup prior to, during, or after the dispensing of the prepared beverage into the beverage cup.

The present disclosure includes disclosure of a drink creation system, further comprising a second cart configured to move in a lateral direction using a plurality of second cart wheels or castors, the second cart operably coupled to the first cart, and a plurality of second cart drawers configured to receive an additional plurality of beverage receptacles having an additional plurality of liquid beverages therein, wherein the second cart is refrigerated and can be set to a second desired refrigerated temperature.

The present disclosure includes disclosure of a drink creation system, further comprising the plurality of beverage receptacles having the liquid beverages therein, the additional plurality of beverage receptacles having the additional plurality of liquid beverages therein, and an ice source positioned upon or within the first cart, the ice source configured to provide a quantity of ice.

The present disclosure includes disclosure of a drink creation system, wherein when a beverage order is placed using a software application, said beverage order is received by the dispenser controller, which operates to cause the beverage dispenser to dispense a prepared beverage into a beverage cup positioned relative to the beverage dispenser.

The present disclosure includes disclosure of a drink creation system, wherein the prepared beverage comprises one or more liquid beverages from the plurality of liquid beverages within the first cart and/or one or more liquid beverages from the additional plurality of liquid beverages within the second cart.

The present disclosure includes disclosure of a drink creation system, wherein the prepared beverage comprises one or more liquid beverages from the additional plurality of liquid beverages within the second cart.

The present disclosure includes disclosure of a drink creation system, wherein the dispenser controller is configured to display information regarding the beverage order on a screen coupled to or formed as part of the dispenser controller.

The present disclosure includes disclosure of a method, comprising providing a software application for use by a user, the software application configured to provide the user with access to make a beverage order, wherein said software application is configured to receive the beverage order and relay said beverage order to a dispenser controller, facilitate the display of beverage information on a display of the dispenser controller, and facilitate the delivery or pickup of a prepared beverage made as instructed by the beverage order.

The present disclosure includes disclosure of a software application, configured to provide a user with access to make a beverage order, receive the beverage order and relay said beverage order to a dispenser controller, facilitate the display of beverage information on a display of the dispenser controller, and facilitate the delivery or pickup of a prepared beverage made as instructed by the beverage order.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1A shows a system comprising a first beverage cart, according to an exemplary embodiment of the present disclosure;

FIG. 1B shows a system comprising a first beverage cart, according to an exemplary embodiment of the present disclosure;

FIG. 2A shows a system comprising a first beverage cart and a second beverage cart, according to an exemplary embodiment of the present disclosure;

FIG. 2B shows a top view of a system comprising a first beverage cart and a second beverage cart in a folded configuration, according to an exemplary embodiment of the present disclosure;

FIG. 2C shows a second beverage cart, according to an exemplary embodiment of the present disclosure;

FIG. 2D shows a block diagram of a system using three carts, according to an exemplary embodiment of the present disclosure;

FIG. 3 shows a screenshot of a portion of a software application, according to an exemplary embodiment of the present disclosure;

FIG. 4 shows a screenshot of a portion of a software application, according to an exemplary embodiment of the present disclosure;

FIG. 5A shows a screenshot of a portion of a software application with a signature drinks button selected, according to an exemplary embodiment of the present disclosure;

FIG. 5B shows a screenshot of a portion of a software application with a cocktails button selected, according to an exemplary embodiment of the present disclosure;

FIG. 5C shows a screenshot of a portion of a software application with a beer button selected, according to an exemplary embodiment of the present disclosure;

FIG. 5D shows a screenshot of a portion of a software application with a wine button selected, according to an exemplary embodiment of the present disclosure;

FIG. 5E shows a screenshot of a portion of a software application with a spirits button selected, according to an exemplary embodiment of the present disclosure;

FIG. 5F shows a screenshot of a portion of a software application with a drinks button selected, according to an exemplary embodiment of the present disclosure;

FIG. 5G shows a screenshot of a portion of a software application with a food drinks button selected, according to an exemplary embodiment of the present disclosure;

FIG. 6A shows a side view of a customized syringe, according to an exemplary embodiment of the present disclosure;

FIG. 6B shows a bottom or base end view of a customized syringe, according to an exemplary embodiment of the present disclosure;

FIG. 7A shows a customized rubberized cork, according to an exemplary embodiment of the present disclosure;

FIG. 7B shows a customized rubberized cork sealing a beverage cup, according to an exemplary embodiment of the present disclosure; and

FIG. 8 shows a block diagram of a device used with a system of the present disclosure, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a drink creation system configured to receive orders, and produce beverages, and deliver the same, on-demand.

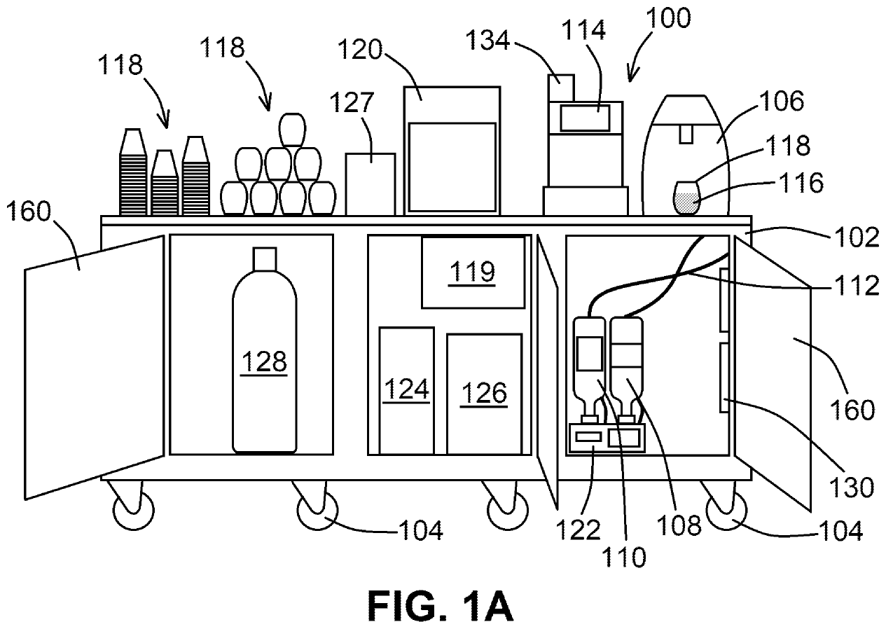

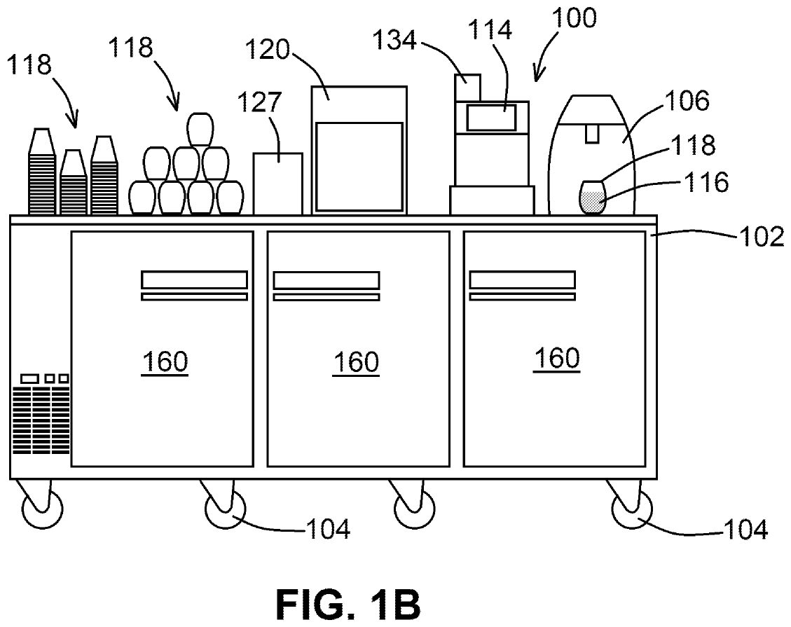

An exemplary drink creation system of the present disclosure is shown in FIG. 1A. As shown therein, drink creation system 100 comprises a cart 102 having castors or wheels 104 to allow cart 102 to roll along the ground as may be desired. Castors or wheels 104 can be cushioned, such as by way of shock absorbers, to assist in a smoother delivery of a cart 102 from one place to another. Carts 102 of the present disclosure are refrigerated, with the refrigeration temperature configured to be set by the user of said carts 102.

Carts 102 of the present disclosure are configured to support a beverage dispenser 106, such as shown in FIG. 1, which is configured to dispense at least one liquid beverage 108 therefrom. In various embodiments, beverage dispensers 106 are connected to a plurality of beverage receptacles 110, such as inverted beverage bottles, by way of a plurality of tubes 112.

Beverage dispensers 106 of the present disclosure are controlled by way of a dispenser controller 114, such as shown in FIG. 1. Dispenser controller 114, in communication with beverage dispenser 106, operates to instruct beverage dispenser as to which liquid beverage 108 to dispense therefrom, including but not limited to mixed drinks (cocktails), beer, wine, soda, juice, water, seltzer, and the like. In at least some embodiments, dispenser controller 114 can communicate with beverage dispenser 106 to dispense liquid beverages 108 comprising varying amounts of beverages from beverage receptacles 110, such as juice, vodka, gin, whiskey, tequila, rum, brandy, amaretto, vermouth, sherry, liqueur, wine, beer, etc. in a desired ratio to produce a prepared beverage 116, such as a known cocktail, or a single ingredient drink like a soda, a juice, a wine, and a beer, for example. Liquid beverages 108 of the present disclosure would be dispensed into a beverage cup 118 which can comprise, but are not limited to, plastic cups, glass cups, wine glasses, whiskey glasses, pint glasses, margarita glasses, and the like.

A variety of beverage cups 118 can be positioned atop or within an exemplary cart 102 of the present disclosure, such as shown in FIG. 1A. In at least one embodiment of a system 100 of the present disclosure, at least two types of beverage cups 118 are used to receive prepared beverages 116 from beverage dispenser 106.

Systems 100 of the present disclosure can also comprise an ice source 119 and optionally an ice shaver 120, so that liquid beverages 108 can be prepared with ice from ice source 119, as may be desired. A first ice source 119 could be a source of ice cubes of whatever shapes, while an ice shaver 120 could be used as a source of shaved ice (such as a stand-alone shaved ice maker or an apparatus configured to receive ice cubes and to shave the same to generate shaved ice).

Beverage receptacles 106 can be contained within cart 102 within one or more cart drawers 122, such as shown in FIG. 1A. As shown therein, cart drawers 122 can comprise a plurality of beverage receptacles 110, such as two, three, four, five, six, seven, eight, or more or fewer beverage receptacles 110. In system embodiments 100 of the present disclosure comprising only one cart 102, a single cart drawer 122 with beverage receptacles 110 may be referred to as a “speed rack.”

Carts 102 of the present disclosure may further comprise a source of fresh water 124 and a liquid waste receptacle 126, such as shown in FIG. 1A. Fresh water 124 can be dispensed using beverage dispenser 106, and fresh water 124 can also be carbonated by way of carbon dioxide source 128 (a receptacle of carbon dioxide and/or a carbonator device) in communication with fresh water 124 and/or beverage dispenser 106. Carbon dioxide source 128 is also what facilitates the actual dispensing of liquid beverage 108 from beverage dispenser 106. In at least one embodiment, liquid waste receptacle 126 is clear/transparent or translucent so that a user can readily identify a level of liquid waste within said liquid waste receptacle 126.

One or more controller panels 130, such as shown in FIG. 1A, can offer adjustments to the various dispensing amounts and rates of the various liquid beverages 108 from said liquid receptacles 110. In at least one embodiment, system 100 comprises two, three, or more control panels 130 positioned within a first cart 102.

One or more beverage labels 132 can be printed using a printer 134 that is configured to print information relating to a particular prepared beverage 116. When a prepared beverage 116 is ordered and ultimately dispensed using beverage dispenser, a beverage label 132 with identifying information, such as the type of prepared beverage 116, the name of the user who ordered it, the location of the user for delivery, the type of garnish, etc., can be affixed to the beverage cup 118 holding said prepared beverage 116. The beverage label 132 and/or the screen of the dispenser controller 114 can also identify whether or not ice should be added into the prepared beverage 116, and optionally which type of ice (cubed or shaved). It can also identify when the ice goes into the beverage cup 118, such as before or after blending in the case of a blended drink, for example.

FIG. 1B shows an exemplary cart 102 of the present disclosure with the doors 160 in a closed configuration, as opposed to FIG. 1A, which shows an exemplary cart 102 of the present disclosure with the doors 160 in an open configuration. It is noted that in FIG. 1B, bars 131 between the doors 160) can be removed, as may be desired, to allow for better use of space within cabinet 102a, 102b, for example, such as allowing for more or larger cart drawers 122 therein.

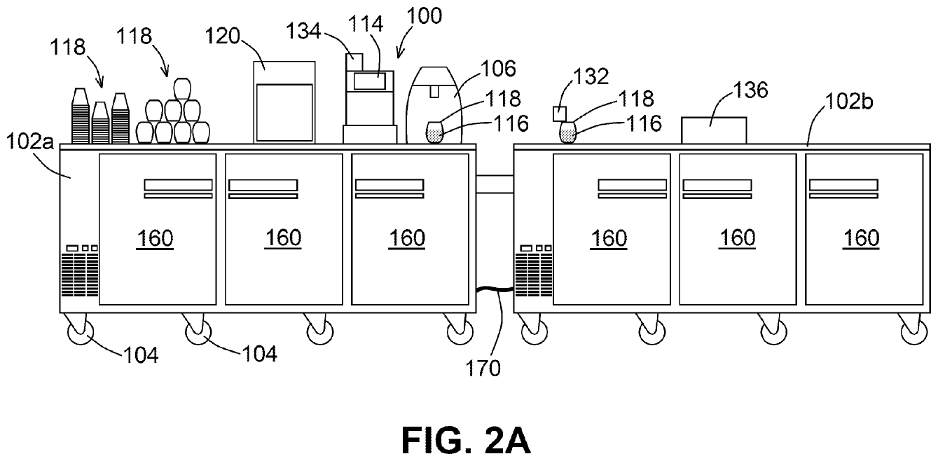

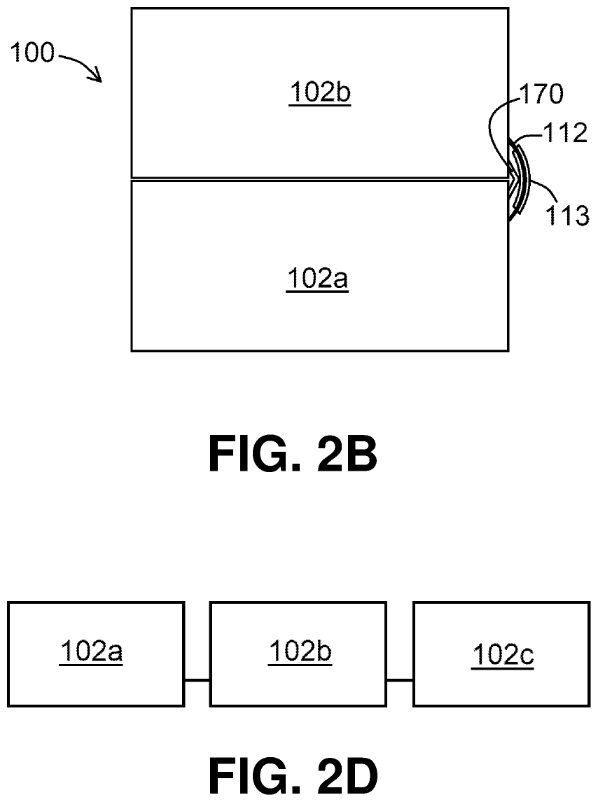

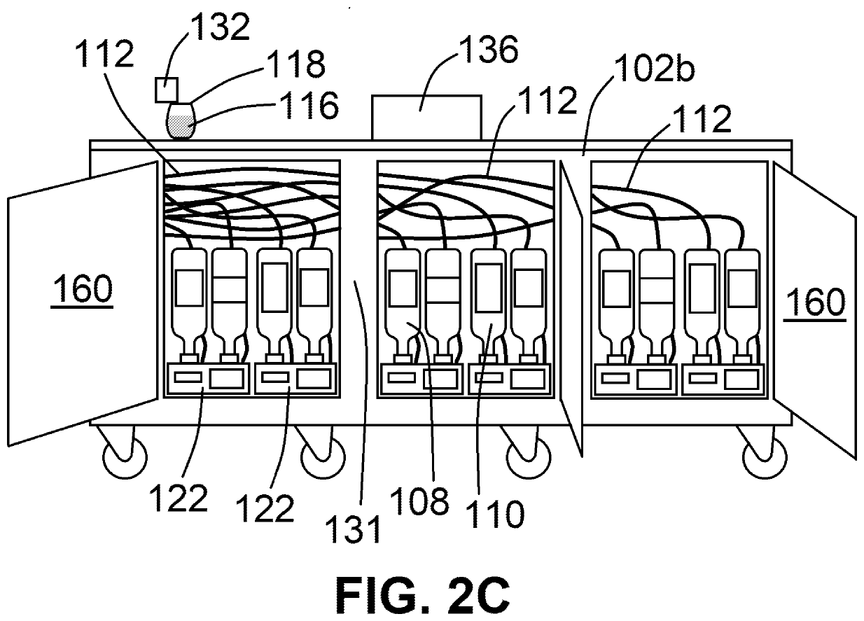

An exemplary system of the present disclosure is shown in FIG. 2A. As shown therein, system 100 comprises two carts 102, namely a first cart 102a and a second cart 102b. Carts 102a, 102b are connected to one another by way of a pivoting latch mechanism 170 (also referred to as a custom hitch) configured to allow said carts 102a, 102b to extend from one another, as shown in FIG. 2A, or to fold against one another, as shown in FIG. 2B, which would allow for potential easier movement of carts 102a, 102b from one location to another. Said pivoting latch mechanism 170 allows movement and variation on all axial directions. Tubes 112 extending between carts 102a and 102b can be insulated using one or more tube insulators 113 covering said tubes. Furthermore, it is noted that the layout of tubes 112 is important as when the carts 102a, 102b, 102c (for example) are swiveled/pivoted about one another, sufficient tube 112 slack is required so not to cause any inadvertent tube 112 disconnections.

As shown in FIG. 2C, second cart 102b can be a refrigerated cart comprising a plurality of beverage receptacles 106 having liquid beverage 108 therein, such as beverage receptacles 106 having liquid beverages such as juice, vodka, gin, whiskey, tequila, rum, brandy, amaretto, vermouth, sherry, a liqueur, wine, and beer, for example. The refrigerated temperatures of each cart 102 a, 102 b can differ, such as setting one cart 102 a, 102 b at 34° F. for white wine, and setting the other cart at 50° F. for liquor and/or red wine, for example.

Second cart 102b can comprise a large number of beverage receptacles 110 therein. For example, and as shown in FIG. 2C, second cart 102b can contain two, three, four, five, six, or more or fewer cart drawers 122, with each cart drawer comprising two, three, four, five, six, seven, eight, or more or fewer beverage receptacles 110 each. In at least one embodiment of a system 100 of the present disclosure, second cart 102b contains six drawers 122, with each drawer 122 configured to receive and retain up to eight beverage receptacles 110 each, for a potential total of forty-eight beverage receptacles 110.

Furthermore, an exemplary system 100 of the present disclosure can comprise a garnish box 136 having various types of garnishes (lime twist, lemon twist, cherries, etc.) therein. Garnish box 136 can be positioned on top of or within at least one cart 102, such as cart 102b shown in FIG. 2A.

As shown in the block diagram of FIG. 2D, additional system 100 embodiments of the present disclosure can use a third cart 102c, such that carts 102a, 102b, and 102c can work together to produce desired prepared beverages 116. For example, cart 102c can comprise any number of features of carts 102a and/or 102b, and can be used to have additional beverage receptacles 110 such as juice, vodka, gin, whiskey, tequila, rum, brandy, amaretto, vermouth, sherry, liqueur, wine, beer, etc. In at least one embodiment, carts 102b and/or 102c may only comprise beverage receptacles 110 containing various beers, such as in keg, partial keg, can, and/or bottle configurations. For example, and in at least one embodiment, cart 102c can be used to retain beer glasses and cans, bottles, and/or kegs of beer, as may be desired.

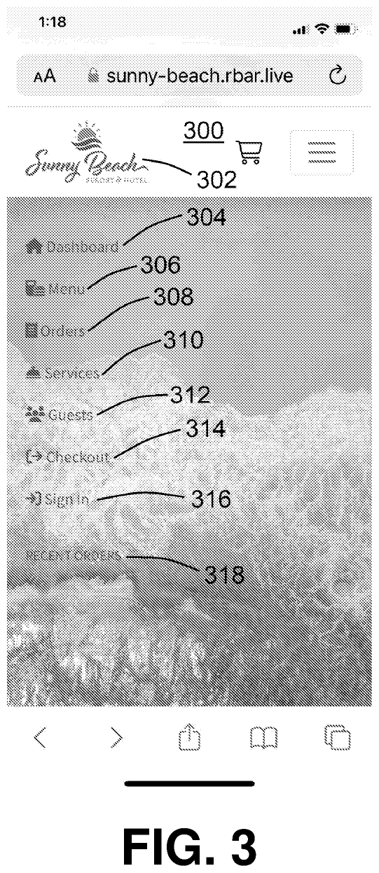

Drink creation systems 100 of the present disclosure are configured to receive orders for liquid beverages by way of a mobile software application 300. An exemplary software application 300 of the present disclosure is shown in FIGS. 3-5G. As shown in FIG. 3, software application 300 can be configured to appear custom for a particular resort, cruise line, hotel, casino, etc., by way of a location identifier 302, such as a logo and/or name of the location, and other branding, such as colors, pictures, and the like. Software application 300 can have several selectable items, such as a dashboard button 304, a menu button 306, an orders button 308, a services button 310, a guests button 312, a checkout button 314, and/or a sign-in button 316. Software application 300 can also show a listing of recent orders, for example, in recent orders section 318, such as shown in FIG. 3.

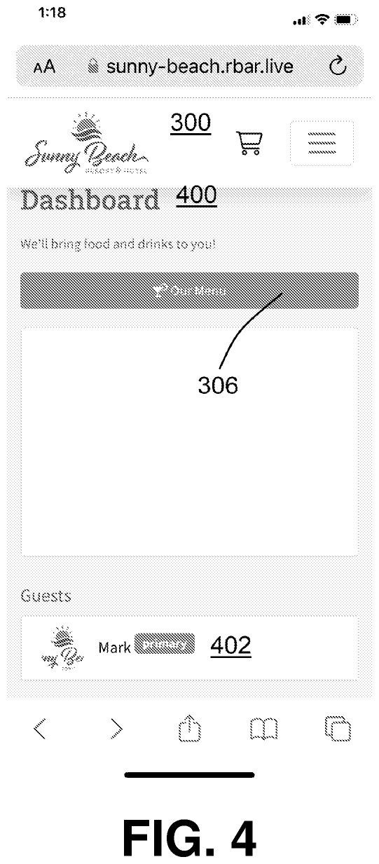

Selecting/pressing dashboard button 304 can reveal the dashboard page 400 of an exemplary software application 300 of the present disclosure, such as shown in FIG. 4. Dashboard page 400 can include various items, such as a menu button 306 and a guests section 402, whereby primary, co-primary, and secondary guests can be identified, said guests being those who are authorized by the software application 300 to make process orders using said application 300 (such as by way of through an existing application program interface (API) to an existing point of sale (POS) or management system), such as ordering drinks at a resort. In at least one embodiment, primary and co-primary guests would have the same level of ordering privileges through software application 300, while secondary guests may have restricted ordering privileges, such as no or limited alcohol purchasing, purchase limits (dollar amounts), and the like.

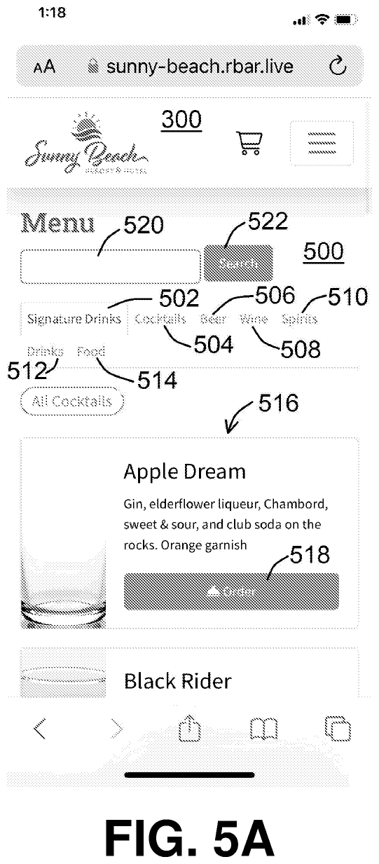

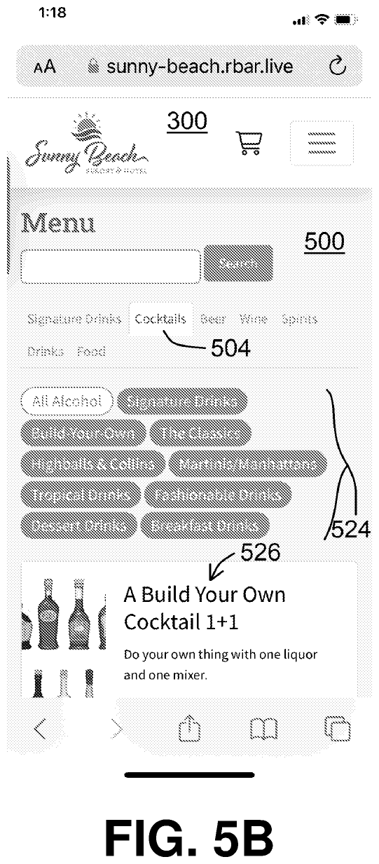

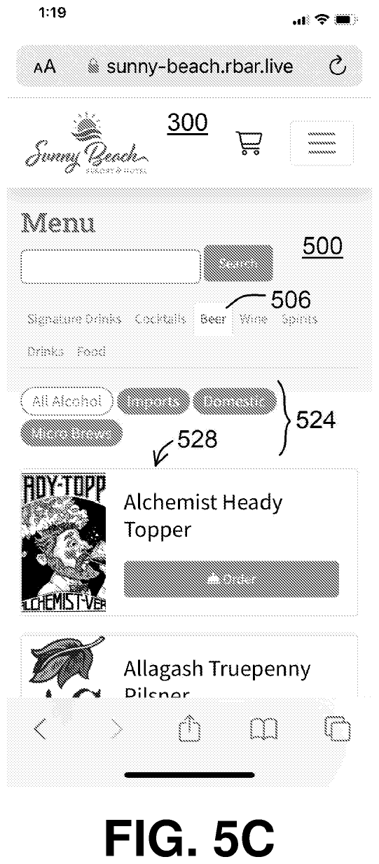

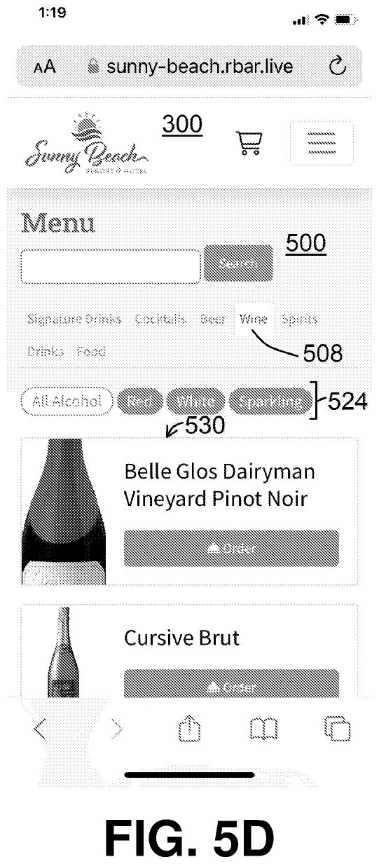

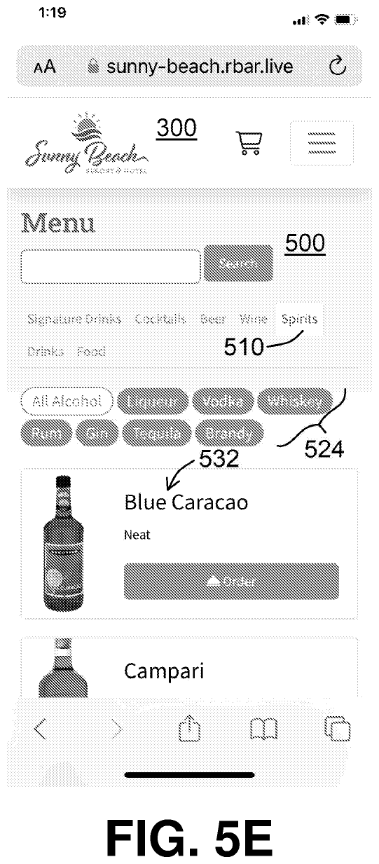

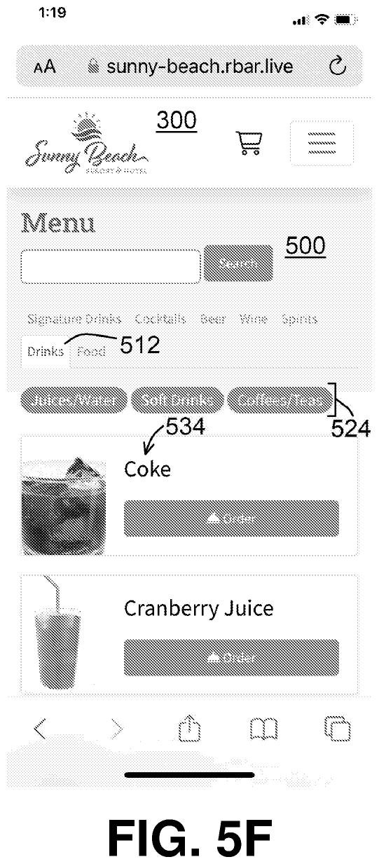

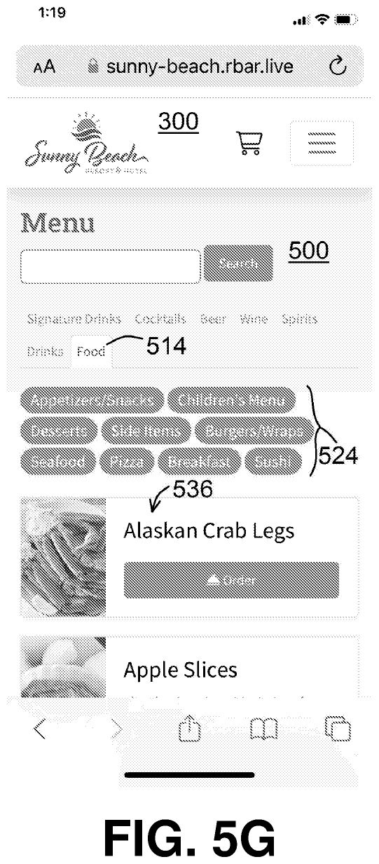

Software applications 300 of the present disclosure can have various additional beverage-specific selections, such as those appearing on an exemplary menu page 500, such as shown in FIG. 5A. As shown in FIG. 5A, an exemplary menu page 500 of the present disclosure may have various menu buttons, such as a signature drinks button 502, a cocktails button 504, a beer button 506, a wine button 508, a spirits button 510, a drinks button 512, and/or a food button 514. Selecting signature drinks button 502, as shown in FIG. 5A, provides for a list of individual signature drinks 516 that can be ordered by way of pressing an order button 518. Furthermore, a search bar 520 is provided so that a user can search for a specific beverage of food item by entering one or more names or keywords in the search bar 520 and pressing the search button 522.

Selecting cocktails button 504, such as shown in FIG. 5B, populates a section of sub-selections 524, which can be chosen to refine the list of individual cocktail drinks 526 shown on said menu page 500. Selecting beer button 506, such as shown in FIG. 5C, similarly populates a section of sub-selections 524, which can be chosen to refine the list of individual beers 528 shown on said menu page 500. Selecting wine button 508, such as shown in FIG. 5D, populates a section of sub-selections 524, which can be chosen to refine the list of individual wines 530 shown on said menu page 500. Selecting spirits button 510, such as shown in FIG. 5E, populates a section of sub-selections 524, which can be chosen to refine the list of individual spirits 532 shown on said menu page 500. Selecting drinks button 512, such as shown in FIG. 5F, populates a section of sub-selections 524, which can be chosen to refine the list of individual beers 534 shown on said menu page 500 populates a section of sub-selections 524, which can be chosen to refine the list of individual drinks 536 shown on said menu page 500. Selecting food button 514, such as shown in FIG. 5G, populates a section of sub-selections 524, which can be chosen to refine the list of individual food items 538 shown on said menu page 500.

Software applications 300 can further be customized so that a user can customize the ordered prepared beverage 116, such as which type of beverage cup 118 to use, what type of ice (cubed, shaved, etc.) to use, potential liquor upgrades, types of garnishes, and the like.

Procedurally, an exemplary embodiment of a software application 300 of the present disclosure can (but is not required to) alert a user as to when the effective “check-in” time is to a particular hotel, resort, cruise, etc., which has the effect of permitting a user to use software application 300 to place food or beverage orders therefrom by clicking a link, scanning a QR code, etc. In at least one embodiment, a link or QR code can be texted or emailed (or sent via some other electronic communication, such as an alert from an app (software application 300)) to a potential user so that the user can click on said link and access directly or indirectly (via app download or web-based software, for example), software application 300. Such a link or QR code is unique to the recipient user, and is good for them, for their stay, at the identified location, in lieu of passwords or logins, for example. Each user can have a unique identifier, and each permitted primary, co-primary, or secondary (sub-user) under the primary user's effective software application account can also have a unique identifier, so that software application 300 can track who makes what order(s) and when. The unique identifier and/or the link or QR code are unique to the user, his or her location, and length of stay, for example. At “check out” time, all software application 300 portals can close, and no further orders can be made using software application 300 until a user of said application 300 “checks in” once again. Each guest “stay” creates a new, unique link, and old links are forever done after checkout.

An exemplary system 100 of the present disclosure can be operated by one, two, or more people. For example, and in at least one system embodiment 100, a first person can place ice (if needed) into a beverage cup 118 and operate beverage dispenser 106 by way of dispenser controller 114 to dispense a prepared beverage 116. A second person could then add any potential garnish to said prepared beverage 116, affix a beverage label 132 to said beverage cup 118, and place the beverage cup 118 having said prepared beverage 116 upon an area of a cart 102 (or 102a, 102b) to be retrieved by the user who ordered the beverage or by an additional person who picks up and delivers said prepared beverage 116.

Systems 100 of the present disclosure can have desired service areas, stations, and machines. A service area, for example, is a geographic area identified by a global positioning system (GPS) that can be modified, for example, based upon the time of day. For example, a service area can comprise a pool area at a hotel or resort, and said service area can be operable from, for example, 10:00 am to midnight, for example, or within a different time frame. Such an embodiment allows users to only order prepared beverages 116 during that defined time frame for GPS delivery within said service area. After midnight or before 10:00 am, for example, prepared beverages 116 would not be deliverable to that specific service area, and instead would be available for individual pickup or delivery to a hotel room, for example.

A station, as referenced herein, is a location where one or more carts 102 of the present disclosure would reside at a particular hotel, resort, casino, cruise ship, party venue, etc. For example, a service area may be a ballroom, while the station is located around the corner from the ballroom in a hallway. Systems 100 of the present disclosure may serve multiple service areas using multiple stations, for example, with each station operable within a desired service area, so that, for example, the closest station to a service area would be the station that prepares the prepared beverage 116 ordered for delivery within said service area. Systems 100, being mobile, can move between stations throughout the day to service demand and/or to meet desired schedules.

Machines refer to the actual equipment used in connection with exemplary systems 100 of the present disclosure. For example, multiple carts 102 with a beverage dispensers 106 and other equipment thereon and/or therein can be assigned to various stations, and ultimately move throughout the day to different stations, such as, for example, when a party adjourns from a ballroom to an outdoor location. A battery back-up system 127 can be used with carts 102a, 102b, 102c, as may be desired, so that power is available to use systems 100 of the present disclosure while they are being moved from one station to another, for example. Such flexibility of systems 100 of the present disclosure allows one or more carts 102 to be positioned at desired stations throughout the day to accommodate users of software applications 300 with their food or beverage orders. Software applications 300 can change their serviceability during the day, as noted above, so that options for delivery and/or pickup can change as the locations of stations change and as the time of day changes, for example.

Hotel, resort, casino, or cruise staff, for example, who deliver prepared beverages 116 to those who ordered them can rely on using a smartphone, tablet, smartwatch, or other portable device having GPS capability to effectively deliver said beverages 116. Servers/delivery people only need GPS when GPS delivery is chosen by a guest/user. GPS can be allowed or not offered on a particular property, at the property's discretion. For example, when a prepared beverage 116 is ready for delivery to the user of software application 300 who ordered said beverage, the smartphone, tablet, smartwatch, or other portable device having GPS capability can display an identifier for the particular prepared beverage 116, a picture/photograph of the user who ordered the prepared beverage 116, a map showing the location of the user who ordered the prepared beverage 116, etc., so that the prepared beverage 116 is picked up and delivered to the appropriate user. In such an embodiment, for example, each user of software application 300 would need to upload a photograph so that the delivery staff knows who to deliver to within the identified GPS location. In addition to delivery, users who have ordered prepared beverages 116 can pick them up at a station (cart 102) and/or at other predetermined locations, such as the user's private room. In at least one embodiment, if a guest/user does not upload a picture/photograph, GPS delivery of a beverage 116 may be unavailable.

The present disclosure also includes disclosure of a system and method for producing a liquid beverage that is traditionally shaken or stirred, such as a martini or a manhattan, without requiring said beverage to be physically shaken or stirred.

Shaking or stirring a mixed drink accomplishes three tasks, namely 1) to mix the ingredients therein, 2) to cool the mixed drink (as shaking or stirring generally involves the use of ice), and 3) to add water to the mixed drink by way of some melted ice. If a mixed drink is shaken with ice, for example, it can then be poured into a beverage cup 118 using a shaker strainer so that only small pieces of ice ultimately make it into said beverage cup 118.

In at least one embodiment of a system 200 of the present disclosure, system 200 comprises an ice source 119, in particular a source of ice 119 so to make shaved ice using ice shaver 120, whereby said shaved ice is used in connection with the production of an exemplary prepared beverage 116 of the present disclosure. Instead of shaking or stirring a mixed drink, an exemplary prepared beverage 116 of the present disclosure can be prepared by first adding some shaved ice to a beverage cup 118 and then dispensing the liquid beverages 108 from the beverage dispenser 106 into said beverage cup 118, causing an effective flash chilling of said liquid beverages 108. It is noted that liquid beverages 108 would already be chilled within cart 102a, 102b, 102c, so that extra chilling is not necessary when preparing a prepared beverage 116 of the present disclosure. This dispensing action has the effect of mixing the drink contents with the shaved ice, which accomplished the three tasks noted above (mixing, cooling, and adding water due to ice melt). It further has the effect of the resulting prepared beverage 116 having some small flakes of shaved ice therein, similar to that of a shaken and strained cocktail.

The present disclosure also includes disclosure of a system for producing a cream-based drink without requiring said beverage to be physically shaken or stirred.

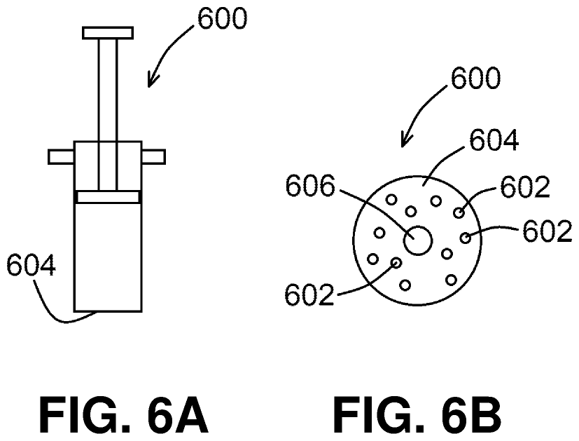

In at least one embodiment of a system 100 of the present disclosure, system 100 is used in connection with a modified syringe 600, such as shown in FIGS. 6A and 6B. Modified syringes 600 of the present disclosure can comprise stainless steel or plastic syringes, whereby the protruding end of the syringe can be removed (such as shown in FIG. 6A), and whereby several additional holes 602 are defined within a base 604 of the syringe 600 around central aperture 606, such as shown in FIG. 6B).

When a cream-based drink is prepared using system 100 of the present disclosure, it is made using beverage dispenser 106 whereby a prepared beverage 116 is introduced into a beverage cup 118. A layer of crème liqueur or cream is added to the prepared beverage 116, but instead of shaking or stirring the prepared beverage 116, syringe 600 is used to draw up the crème drink, which has the effect of introducing air into the beverage, so no need to shake or stir the beverage using any sort of secondary glassware. Drawing up and reintroducing prepared beverage 116 from and to beverage cup 118 has the effect of shaking or stirring the beverage without requiring the specialized tools or glassware to do so. This effective “whipping” of the beverage, by way of prepared beverage 116 flowing into main aperture 606 and additional holes 602 and out again, keeps the remainder of the prepared beverage 116 looking good while effectively aerating the crème portion of said beverage 116. Syringe 600 can then be effectively cleaned using a quat (quaternary ammonium compound) cleaner (a rinseless sanitizer) and be ready for use for the next prepared beverage 116.

The present disclosure also includes disclosure of devices and methods for producing shaken beverages, such as shaken cocktail beverages with ice, while minimizing the overall amount of receptacles used to create and serve said beverages.

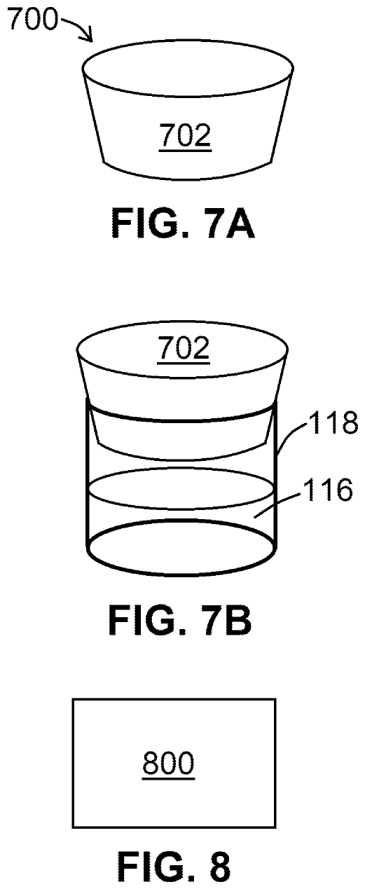

An exemplary device of the present disclosure is shown in FIG. 7A. As shown therein, device 700 comprises a stopper 702 (also referred to generally as a cork, regardless of the type of material it is made of). Stoppers 702 of the present disclosure comprise a food-grade material, such as a food-grade rubber, with said material having hydrophobic properties so that any liquid that comes into contact with said stopper 802 is not absorbed by or retained within or upon said stopper 802 in any fashion.

FIG. 7B shows an exemplary stopper 702 of the present disclosure engaging an upper portion of a beverage cup 118 of the present disclosure.

In at least one embodiment of preparing a prepared beverage 116 of the present disclosure, prepared beverage 116 is dispensed into a beverage cup 118, and then stopper 802 is applied to beverage cup 118 to effectively seal prepared beverage 116 within beverage cup 118. Beverage cup 118 is then shaken or inverted, such as shaken or inverted twice, to mix the contents of prepared beverage 116 within said beverage cup 118. Stopper 802 can then be removed, and beverage cup 118 is ready to be served. As noted above, and because stopper 802 comprises a hydrophilic material that does not retain or absorb any liquid, stopper 802 does not get “dirty” and is therefore ready for use with the next mixed prepared beverage 116.

The present disclosure includes disclosure of an additional device and method for creating cream-based drinks. In at least one embodiment of a system 100 of the present disclosure, system 100 is used in connection with a dual spring immersion blender/milk frother (referred to herein as immersion device 800), as shown in block diagram form in FIG. 8. When used at its lowest operating speed, immersion device 800 can be used to whip a cream-based beverage without creating any sort of splash on the side of the beverage cup 118. If used at a higher speed, the immersion device 800 would cause the prepared beverage 116 to splash against the side of the beverage cup 118, creating a visually undesirable end result.

When a cream-based drink is prepared using system 100 of the present disclosure, it is made using beverage dispenser 106 whereby a prepared beverage 116 is introduced into a beverage cup 118. A layer of crème liqueur or cream is added to the prepared beverage 116, but instead of shaking or stirring the prepared beverage 116, immersion device 800 can be used to whip the crème drink, which has the effect of introducing air into the beverage, so no need to shake or stir the beverage using any sort of secondary glassware. This effective whipping of the beverage, by way of prepared beverage 116 using immersion device 800, keeps the remainder of the prepared beverage 116 looking good while effectively aerating the crème portion of said beverage 116. Immersion device 800 can then be effectively cleaned using a quat (quaternary ammonium compound) cleaner (a rinseless sanitizer), after a brief water rinse/splash, and be ready for use for the next prepared beverage 116.

The present disclosure also includes disclosure of devices and methods for producing blended beverages, such as blended cocktail beverages with ice, while minimizing the overall amount of receptacles used to create and serve said beverages.

In at least one embodiment of a system 100 of the present disclosure, system 100 is used in connection with a dual spring immersion blender/milk frother (referred to herein as immersion device 800), as shown in FIG. 8. When used at its lowest operating speed, immersion device 800 can be used to initially mix/blend the ingredients of a blended prepared beverage 116, such as one that already has shaved ice included therein. Using the same immersion device 800, and pressing a booster/turbo button, said device 800 can briefly increase the rate of blending the drink using the same tip (a dual spring tip, for example). Immersion device 800 can then be effectively cleaned using a quat (quaternary ammonium compound) cleaner (a rinseless sanitizer), after a brief water rinse/splash, and be ready for use for the next prepared beverage 116.

There are several benefits for using systems 100 and/or software applications 300 of the present disclosure. For example, software applications 300 can be “white labeled” to show names, logos, etc., of the hotels, resorts, casinos, cruises, etc., providing a customized experience. Actual use of systems 100 by employees results in no overpour of liquid beverage 108 (as the beverage dispensers 106 dispense a precise amount of liquid beverage 108), and they require less labor than traditional bartending due to the rapid production of prepared beverages 116. Systems 100 of the present disclosure can be run by as few as one or two people, resulting in reduced labor costs. The speed of prepared beverage 116 production allows for quick remote ordering, less waiting, speedy delivery, and the like. With the large number of liquid beverages 108 used in the various carts 102 (102a, 102b, for example), literally thousands of recipes can be offered, and users can also request customized prepared beverages 116 as well. In at least one embodiment, it is noted that a two-person team can create up to about 400 drinks per hour, with rates of 300 drinks per hour being sustainable over time with bottle (of liquid beverage 108) changing, water filling, ice refilling, and the like. It is also noted that a large quantity of beverage 116 options provides a way for users to spend time and potentially try beverages 116 of interest, as more time reviewing the menu can lead to more selection and purchasing of beverages 116.

As referenced herein, the process of ordering prepared beverages 116 is novel and unique and can be performed in a way to optimize the user's/guest's experience at the venue. For example, and as referenced herein, software 300 can be used, whereby guests are welcomed to the platform for a unique set of dates, such as by way of a text message alert. Once the guest/user has activated the system (uploading photograph, identifying primary, co-primary, and secondary users, etc.), orders (such as for prepared beverages 116) can be placed using software 300, whereby the user selects the delivery location when checking out (such as delivery via GPS, pickup at a pickup station or in the user's room, etc.). The placed order is then sent to beverage dispenser 106 and/or dispenser controller 114, whereby instructions embedded in the order direct which type of beverage cup 118 to use and which type and how much ice to use, if any (whereby some ice can go in before liquid, some after, depending on the type of beverage). The correct/desired beverage cup 118 is then used in connection with beverage dispenser 106 and the prepared beverage 116 is made using the dispenser controller 114. A printer 134 can be used to print a linerless/sticky label (a beverage label 132) for the prepared beverage 116 that was just made using beverage dispenser 106. Cream drinks, as referenced herein, can be addressed to aerate as may be necessary. The beverage label 132 can be applied to the beverage cup 118, and the appropriate garnish, if any, can be applied to the prepared beverage 116 (with the garnish type being noted on the beverage label 132 and/or a screen or display of the dispenser controller 114). Once finalized, prepared beverage 116 can be delivered to the guest using GPS delivery or by way of delivering said beverage 116 to a pickup station or to the guest's room, for example. When the prepared beverage 116 is picked up at the cart 102a, 102b, 102c for delivery, the guest is notified using software 300 that the prepared beverage 116 is on its way to the chosen/selected delivery point. Once delivered, the order is identified as being completed in the software 300 system.

Furthermore, it is noted that at any particular venue (hotel, resort, casino, cruise ship, etc.), multiple carts 102 (102a, 102b) could be used, and when an order for a beverage is placed using software application 300, said order is routed to the cart 102 either closest to the GPS location of the source of the order, or to a pre-determined cart based upon the GPS location of the source of the order. In such an embodiment, multiple carts 102 can serve multiple locations with efficient prepared beverage 116 generation.

In various embodiments of systems 100 of the present disclosure, carts 102 or 102a, for example, can be connected to a source of water, sewer, and/or carbon dioxide, such that one or more of a fresh water source 124, liquid waste receptacle 126, and/or carbon dioxide source 128 do not need to be resident upon or within carts 102 or 102a (or even carts 102b, in various embodiments). In various locations, such as hotels, resorts, casinos, and the like, it may be desired to have one or more carts 102 remain stationary at a particular location, such that one or more of a fresh water source 124, liquid waste receptacle 126, and/or carbon dioxide source 128 do not need to be resident upon or within cart 102, as sources of water, sewer, and/or carbon dioxide can be provided directly at such a location. In other embodiments whereby it is important to be able to move carts 102 (102a, 102b) to various locations, fresh water source 124, liquid waste receptacle 126, and/or carbon dioxide source 128 would be resident upon or within carts 102.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1.-57. (canceled)

58. A method of creating a prepared beverage, comprising the steps of:
receiving a beverage order initiated via software instruction;
processing the software instruction so to instruct the creation of a prepared beverage using a drink creation system based upon the beverage order, the drink creation system comprising:
a plurality of chilled beverage receptacles having chilled liquid beverages therein,
a beverage dispenser coupled to the plurality of chilled beverage receptacles, and a dispenser controller in communication with the beverage dispenser;
based upon information provided on a screen, performing the steps of:
selecting a beverage cup based upon the software instruction;
optionally adding shaved ice to the beverage cup;
dispensing one or more chilled liquid beverages from the plurality of chilled beverage receptacles into the beverage cup using the beverage dispenser;
optionally using an immersion device to whip or blend contents of the beverage cup; and
optionally adding cubed ice to the beverage cup; and
based upon information provided on a printed beverage label, performing the steps of:
optionally adding a garnish to the beverage cup; and
identifying a specific location for the beverage cup to be delivered based upon the printed beverage label.

59. The method of claim 58, further comprising the step of:
delivering the beverage cup to the specified location.

60. The method of claim 58, wherein the step if optionally adding shaved ice to the beverage cup is performed to add the shaved ice to the beverage cup.

61. The method of claim 60, wherein the step of optionally using an immersion device to whip or blend contents of the beverage cup is performed to use the immersion device to whip or blend the contents of the beverage cup.

62. The method of claim 61, further comprising the step of:
delivering the beverage cup to the specified location.

63. The method of claim 61, wherein the step of optionally adding a garnish to the beverage cup is performed to add the garnish to the beverage cup.

64. The method of claim 63, further comprising the step of:
delivering the beverage cup to the specified location.

65. The method of claim 61, wherein the step of optionally adding cubed ice to the beverage cup is performed to add the cubed ice to the beverage cup.

66. The method of claim 65, further comprising the step of:
delivering the beverage cup to the specified location.

67. The method of claim 65, wherein the step of optionally adding a garnish to the beverage cup is performed to add the garnish to the beverage cup.

68. The method of claim 67, further comprising the step of:
delivering the beverage cup to the specified location.

69. The method of claim 58, wherein the step of optionally adding cubed ice to the beverage cup is performed to add the cubed ice to the beverage cup.

70. The method of claim 69, further comprising the step of:
delivering the beverage cup to the specified location.

71. The method of claim 69, wherein the step of optionally adding a garnish to the beverage cup is performed to add the garnish to the beverage cup.

72. The method of claim 71, further comprising the step of:
delivering the beverage cup to the specified location.

73. The method of claim 58, wherein the step of optionally adding a garnish to the beverage cup is performed to add the garnish to the beverage cup.

74. The method of claim 73, further comprising the step of:
delivering the beverage cup to the specified location.

75. The method of claim 58, wherein the drink creation system further comprises a first station, the first station having the beverage dispenser thereupon.

76. The method of claim 75, wherein the drink creation system further comprises a second station, the second station having the plurality of chilled beverage receptacles therein.

77. The method of claim 58, wherein the screen is coupled to or formed as part of the dispenser controller.

78. The method of claim 58, wherein the software instruction is received from an application program interface (API) to an existing point of sale (POS) or management system or is received from mobile software.
